(19) United States
(12) Patent Application Publication
(10) Pub. No.: US 2022/0176863 A1
(43) Pub. Date: Jun. 9, 2022

(54) ROOF STRUCTURE WITH A BELLOW

(71) Applicant: PARAT Beteiligungs GmbH, Neureichenau (DE)

(72) Inventor: Martin KREMSREITER, Neureichenau (DE)

(21) Appl. No.: 17/519,786

(22) Filed: Nov. 5, 2021

(30) Foreign Application Priority Data
Dec. 8, 2020 (DE) 10 2020 132 671.8
Dec. 9, 2020 (DE) 10 2020 132 873.7

(51) Int. Cl. B60P 3/34; B60J 7/08; B32B 5/02; B32B 5/26; B32B 27/32; B32B 27/40; B32B 27/36; B32B 27/12

(52) U.S. Cl. CPC B60P 3/341; B60J 7/08; B32B 5/024; B32B 5/263; B32B 27/322; B32B 27/40; B32B 2262/0276; B32B 27/12; B32B 2605/08; B32B 2255/26; B32B 2307/732; B32B 2255/02; B32B 27/36

(57) ABSTRACT

A roof construction for a motor vehicle, including a displaceable roof element which is displaceable between a retracted out-of-use position and an extended use position, wherein the roof element in its extended use position is in a spaced-apart position relative to a body of the vehicle. Arranged on the roof element is a folding bellows which, when the roof element is in the use position, assumes an opened state and bridges a gap between the roof element and the body, and which, when the roof element is in the out-of-use position, assumes a compressed state collapsed in folds. The folding bellows has a layer structure with at least two different layers.

The invention relates firstly to a roof construction according to the preamble of claim 1.

Such roof constructions are known and widely used. For example, such roof constructions are known from vehicles, which are also referred to as campers or motorhomes, which have a roof element which can be opened. As a result of a displacement of a roof element into an extended use position, sleeping space or additional sleeping space can be generated or the vehicle interior can be made larger.

In the case where the motor vehicle, for example as part of a holiday trip, has been driven to a parking space for an overnight stay, a user is able to displace the roof element manually, optionally also in a motor-driven manner, from the out-of-use position into the extended use position. A pop-up device in particular can serve to hold the roof element in the extended use position, for example with the aid of rods and/or a linkage system.

In its use position, the roof element is in a spaced-apart position relative to a region of the body of the vehicle. It is already known in the prior art to provide a folding bellows which is fixed with a first region or portion to the body and with another, second region or portion to the roof element. When the roof element is in the use position, the folding bellows is opened and bridges the gap between the roof element and the body. The interior of the vehicle, which is made larger or expanded by the extended roof element and by the opened folding bellows, is thus closed securely, in particular in a water-tight and/or non-transparent or light-tight manner, optionally also in an air-tight or soundproof or sound-reducing manner, relative to the exterior.

When the roof element—once it is no longer required—is transferred back into its out-of-use position, the folding bellows can be collapsed into a compressed state. In particular, such collapsing takes place in a space-saving manner in folds, hence the name “folding bellows”.

As a result of the displacement of the roof element from the out-of-use position into the use position, the folding bellows is automatically transferred from a compressed state into an opened state. The same applies analogously to the reverse movement.

The applicant has for some time been developing and manufacturing folding bellows for roof constructions of the described type.

It has thereby become apparent to the applicant that, owing to the collapsing behavior of the folding bellows, kink points can occur in the material of the folding bellows when a roof construction is used for prolonged periods of time. Occasionally, the material that is used can even tear as a result of the kinks that form. It is known to use cotton or polyester to produce folding bellows.

The object of the invention is to further develop the roof construction which has become known and for which there is no documentary evidence, such that the collapsing behavior of the folding bellows into a compressed state is improved and the disadvantageous effects described in the prior art are eliminated or reduced.

The invention achieves this object with the features of claim 1, in particular with those of the characterizing part, and is accordingly characterized in that the folding bellows comprises a layer structure which has at least two different layers.

The principle of the invention consists essentially in that, in a modification of the material used in the folding bellows of the prior art, use is now made of a layer structure. According to the invention, the layer structure comprises at least two different layers or plies. Preferably there are three layers or at least three layers, namely two outer layers and a middle layer arranged therebetween.

The layers can preferably consist of different materials. The different layers are advantageously fixed to one another.

The invention recognizes that, by providing a layer structure of different layers, a modified collapsing behavior of the folding bellows can be achieved:

While it was possible in the case of a folding bellows of the prior art using only a single material layer, for example of cotton or polyester, that, when the folding bellows was stored in the compressed state, folds or kinks developed which, in particular when the folding bellows was in the compressed state for prolonged periods of time, turned into kinks or even tears which were visible—in the opened folding bellows—or left visually discernible marks or shading, it is possible according to the invention to provide a specially adapted layer structure which counteracts the formation of such kinks. By changing the material chosen for the folding bellows, the impairment noticed in the prior art can be eliminated or considerably reduced. In particular, the layer structure provided according to the invention can prevent kinks from being permanently imprinted into the material via kink points.

In particular, the collapsing behavior of the folding bellows can be improved by the layer structure provided according to the invention to the effect that a modification of the roof construction or a modification of the roof element or a modification of the body, or a modified construction of a pop-up device or of a storage space is not required. In principle, the roof construction known per se can be wholly retained. It is sufficient to use a different material for the folding bellows and to employ the multi-ply layer structure according to the invention.

Advantageously, the layer structure can comprise a textile layer and a plastics layer. The plastics layer can consist, for example, of a melting adhesive or melting plastics material, that is to say in particular of a thermoplastic. The melting adhesive or plastics material can penetrate the textile layer at least partially during the manufacture of the layer structure and bond thereto.

When the folding bellows is collapsed in a compressed state, the layer structure, which now consists of different layers, can on the one hand provide high flexibility and, if required, also a certain extensibility. However, it can also apply a restoring force which, in particular in the portions of the bending regions, counteracts folding along a fold line and/or distributes the forces that occur in the bending region over larger surface portions.

In particular, as a result of the particular choice of the layer structure for the folding bellows, it can be provided on a microscopic scale that certain minimum radii are still ensured in the bending regions of the fold and the bending forces occurring there are distributed over larger material portions or larger areas. The formation of tears can thereby be counteracted at an early stage. As a result of the choice of particular material properties of the layer structure, it is also possible to prevent kink lines, fold lines or kink points from permanently and showing in the material.

In the prior art it was possible, as a result of prolonged collapse in the compressed state over a very long period of time or as a result of frequent collapsing of the folding bellows in the compressed state, that kink lines and kink points showed when the folding bellows was opened. These were also readily discernible and unsightly due to color differences or shading, for example.

In the folding bellows modified according to the invention, such visual impairments and unsightliness are no longer discernible.

The invention additionally recognizes that, owing to the construction, it is not always clearly determined where exactly bending regions form. Also, on collapsing of the folding bellows, different positioning of individual regions of the folding bellows can occur as a result of the significant defibration. Unexpectedly high point loads can also occur in certain regions, likewise owing to the construction, for example because material regions of the folding bellows are clamped between moving parts of the roof construction on opening or closing of the roof element. Such point loads on the material can also be absorbed and handled considerably better by the layer structure according to the invention.

Finally, by using suitable materials for the layer structure according to the invention, manufacturing-related tolerances in the production of the roof construction can better be compensated for, on account of particular extensibilities and flexibilities of the material of the folding bellows, than in the case of roof constructions of the prior art.

A folding bellows according to the present invention comprises at least one wall portion of an enlarged interior of the vehicle or resulting additional space that is obtained as a result of a displacement movement of the roof element into its extended use position. It is sufficient if the folding bellows extends along a wall portion of the enlarged interior.

The invention includes in particular folding bellows which surround the expanded or additionally created interior of the vehicle in the circumferential direction completely or substantially completely or predominantly.

Advantageously, a portion of the folding bellows extends in the opened state along a plane. However, the invention also includes exemplary embodiments in which the folding bellows in the opened state extends not along a plane but along an arbitrary, predefined, for example also curved, three-dimensional shape, for example also with the aid of additional tensioning elements.

As a result of a displacement of the roof element into its use position, the vehicle interior is enlarged or expanded. For example, as a result of a displacement of the roof element, a sleeping space for the occupants of the vehicle can be created or enlarged. However, the invention also includes the case where, for example, the interior of the vehicle is to be expanded or enlarged in order, for example, to allow users of the vehicle to stand upright or in order to create an additional storage space.

A motor vehicle within the meaning of the present patent application is understood as being, for example, a motorhome, camper, campervan, caravan, etc. A motor vehicle within the meaning of the present patent application can be in the form of a self-powered vehicle, such as, for example, a motorhome, or in the form of a vehicle that is not self-powered, such as, for example, a caravan or a trailer, and configured to be hitched or able to be hitched to a self-powered vehicle.

Exemplary embodiments of a roof construction according to the invention are illustrated in the following figures with only one displaceable roof element. The invention also includes roof constructions, not shown, which have a plurality of displaceable roof elements.

The provision according to the invention of a layer structure for the folding bellows allows the folding bellows to be individually adapted to individual requirements. For example, the layer structure can be configured with layers of different colors, different technical properties, different hardnesses, different elasticities, different extensibilities, different water vapor permeabilities, different water tightnesses, different tightness properties, etc.

The material of the layer structure can thereby also be selected such that a high degree of insensitivity to weather effects, temperature fluctuations, fluctuations in humidity is achieved over a long service life of the folding bellows.

According to the invention, the layer structure has at least two layers. This is advantageous in particular inasmuch as the folding bellows can have a different structure, visual appearance, color or haptics on its side facing the exterior than on its side facing the interior.

According to an advantageous embodiment of the invention, the layer structure has three layers. It is thereby provided in particular that the layer structure has a middle layer, in particular a joining layer, and two outer layers. The first outer layer, the so-called outside layer, is associated with the exterior of the vehicle and the second outer layer, the so-called inside layer, is associated with the interior of the vehicle. The middle layer can in particular be configured to join the two outer layers together.

According to an advantageous embodiment of the invention, the different layers are fixed to one another. A long service life of the layer structure and thus a long service life of the folding bellows can thereby be achieved.

According to a further advantageous embodiment of the invention, the layers of the layer structure consist of different materials. As a result, it is possible to optimize the physical properties of the folding bellows and adapt them individually to the requirements made in a particular case.

According to a further advantageous embodiment of the invention, the layer structure comprises at least one layer of a textile material. This allows conventional materials to be used.

According to a further advantageous embodiment of the invention, the layer of a textile material faces an exterior of the folding bellows. As a result, it is possible to provide a roof construction having a conventional appearance.

According to a further advantageous embodiment of the invention, the layer structure comprises two layers between which there is arranged a joining layer, that is to say a third layer. The joining layer can serve in particular to fixedly join the two layers together permanently.

According to a further advantageous embodiment of the invention, the layer structure comprises at least one layer of a plastics material or having a coating of plastics material. This makes it possible, for example, to provide a planar material with which fixing can also easily be achieved. The plastics material can be provided in particular by a thermoplastic or other suitable, bondable or hot-melt bondable plastics material.

As a result, manufacturing methods for producing such a folding bellows or for producing such a roof construction that are easy to carry out, for example, are possible.

For example, production can be carried out using so-called calendar rollers, which fix the various different layers of the layer structure to one another by applying the layer structure to one another under pressure and with heating. They can serve to melt the plastics material and at the same time provide the required pressing or contact forces.

According to a further advantageous embodiment of the invention, the plastics material is provided by a thermoplastic plastic and/or of a material such as PTFE (polytetrafluoroethylene), PU (polyurethane) or PES (polyester). This embodiment allows known materials to be used.

According to a further advantageous embodiment of the invention, the plastics material is configured meltable, in particular hot-meltable. This permits particularly simple manufacture of a folding bellows according to the invention.

According to a further advantageous embodiment of the invention, the different layers are fixed to one another in regions, in particular areally. Fixing the different layers of the layer structures to one another in regions comprises according to the invention—in contrast to point-wise or line-wise fixing—fixing the layers to one another over a large area or in particular over their entire surface.

In particular, the invention includes exemplary embodiments in which the inside of a first layer and the outside of a second layer, wherein the outside of the second layer faces the inside of the first layer, are fixed to one another over their entire surface. Fixing can take place with the aid of a separate bonding agent, for example an adhesive, or by melting a layer consisting of plastics material or comprising plastics material.

According to an alternative embodiment of the invention, the layers are fixed to one another only in points or in lines.

Instead of or in addition to adhesive bonding, there come into consideration, for example, other fixing means, such as seams, rivets, hook-and-loop fixings or other suitable types of fixing.

According to an advantageous embodiment of the invention, the layer structure is of flexible configuration. This facilitates collapsing of the folding bellows in the compressed state.

According to a further advantageous embodiment of the invention, the layer structure is of resilient configuration. In particular in the region of the kink points or fold points which occur when the folding bellows is in the compressed, collapsed state, particular material properties of the layers used can serve on a microscopic scale, for example, to provide minimum radii in the region of the bending points or to distribute the forces that occur over large areas, in particular in order to avoid or reduce point loads.

According to a further aspect, the invention relates to a folding bellows for a roof construction according to claim 16.

The object of the invention is to provide a folding bellows which is suitable for use in an above-described roof construction from the prior art and which ensures a long working life.

The invention achieves the object with the features of claim 16.

In order to avoid repetition, reference is made for the explanation of the features of the invention according to claim 16 and with respect to the advantageous embodiments to the above statements relating to the preceding claims.

Further advantages will become apparent from the dependent claims not cited and from the exemplary embodiments of the invention illustrated in the drawings. In the drawings:

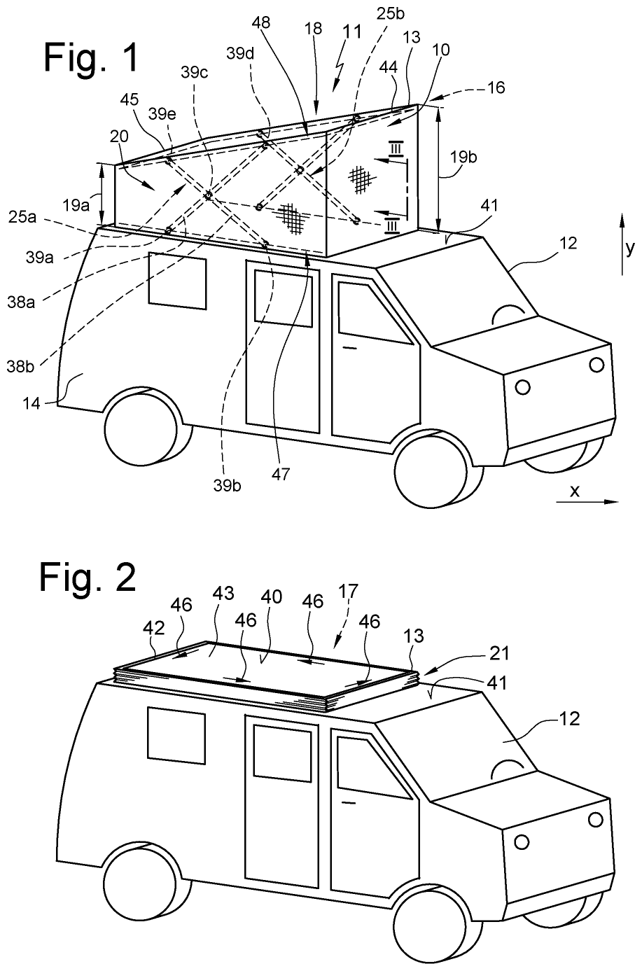

FIG. 1 shows, in a schematic, perspective view, a first exemplary embodiment of a roof construction mounted on a vehicle, having a roof element which is in an extended use position, wherein the folding bellows is in the opened state,

FIG. 2 shows, in a comparable illustration, the roof construction according to FIG. 1 with the roof construction in the out-of-use position and with the folding bellows collapsed in the compressed state,

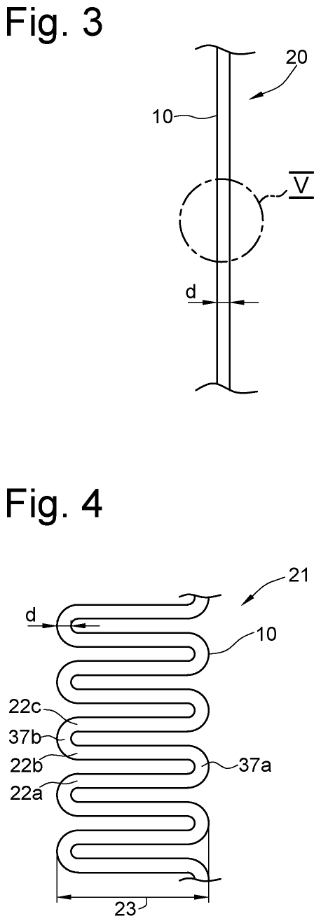

FIG. 3 shows, in a partially cutaway schematic view, a portion of an exemplary embodiment of a folding bellows according to the invention of the roof construction of FIG. 1 in the opened state, approximately along sectional line III-III in FIG. 1.

FIG. 4 shows, in a schematic illustration according to FIG. 3, a portion of the folding bellows of FIG. 3 in a compressed state collapsed in folds,

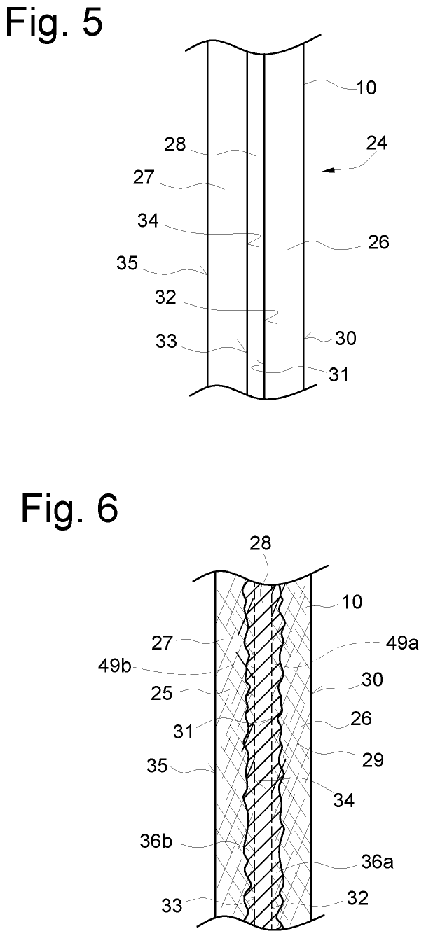

FIG. 5 shows, in an enlarged, partially cutaway, schematic detail view, the folding bellows approximately according to the reference circle V in FIG. 3, wherein a layer structure comprising three layers or plies is shown,

FIG. 6 shows a folding bellows modified with respect to FIG. 5 in a schematic, partially cutaway illustration similar to FIG. 5, showing the different layers and material types, and

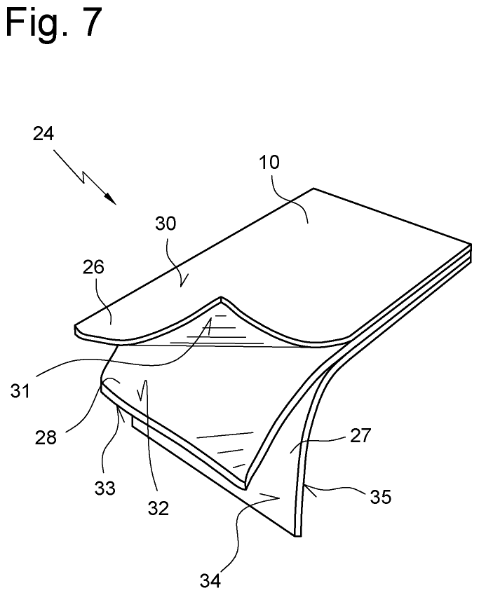

FIG. 7 shows, in a perspective, broken away, schematic, partially exploded view, the layer structure of the folding bellows according to FIG. 6, showing the three different layers.

Exemplary embodiments of the invention are described by way of example in the following description of the figures, also with reference to the drawings. For the sake of clarity—also inasmuch as different exemplary embodiments are concerned—identical or comparable parts or elements or regions are denoted by identical reference signs, in some cases with the addition of lowercase letters.

Features which are described only in relation to one exemplary embodiment can also be provided within the scope of the invention in any other exemplary embodiment of the invention. Such modified exemplary embodiments—even if they are not illustrated in the drawings—are included in the invention.

All the disclosed features are essential to the invention on their own. The disclosed content of the associated priority documents (copy of the preliminary application) and of the cited publications and of the described devices of the prior art is hereby also included in its entirety in the disclosure of the application, also for the purpose of incorporating individual or multiple features of these documents into one or into multiple claims of the present application.

The folding bellows denoted in its entirety by the reference numeral 10 and a roof construction denoted in its entirety by the reference numeral 11 will first be explained with reference to FIG. 1:

FIG. 1 shows, in a schematic view, a vehicle 12 which is a motorhome, a so-called camper, which is used, for example, for tourist purposes and provides convenient overnight accommodation. Without discussing the interior of the vehicle in detail, a comparison of FIGS. 1 and 2 clearly shows that the vehicle 12 has a displaceable roof element 13. The displaceable roof element 13 can comprise, for example, a frame-like structure 42 which surrounds a sheet-form part 43. The roof element 13 can be displaced manually or optionally also in a motor-driven or motor-assisted manner from a retracted out-of-use position 17 illustrated in FIG. 2 into an extended use position 16 illustrated in FIG. 1, in which an interior of the vehicle 12 is expanded.

FIGS. 1 and 2 are to be interpreted only schematically: In particular, when the roof element 13 is in the state in which it is in the out-of-use position 17 according to FIG. 2, its upper side 40 can also be flush with the upper side 42 of the vehicle 12—contrary to what is illustrated in FIG. 2.

As is indicated in the figures, the roof element 13 can comprise a frame structure 42. The frame structure 42 can extend around a sheet-form portion 43 formed along a plane. It can thereby be provided in particular that the frame structure 42 is also formed along a plane. The invention also includes the case where the roof element 13 is solid. The invention further includes the case where the roof element 13 is not formed along a plane but extends, for example, along an arbitrary space curve and is curved, for example, once or multiple times. The roof element 13 can, for example, additionally also comprise transparent windows, not shown, and/or shading devices, in particular for windows.

In the exemplary embodiment of the invention according to FIG. 1, the frame structure 42 is filled by a sheet-form element 43, for example by a body skin, for example of metal or plastics material.

FIG. 1 shows—only schematically—two pop-up devices 25a and 25b. These serve to transfer the roof element 13 into the extended use position 16 according to FIG. 1 and to hold it in that position. In the out-of-use position 17 of the roof element 13 illustrated in FIG. 2, the pop-up device 25a on the right in the direction of travel of the vehicle 12 is not visible. It is advantageously enclosed or overlapped by the contours of the roof construction 11 and/or by contours of the body 14 of the vehicle 12.

The pop-up device 25a is illustrated only schematically in FIG. 1. In the exemplary embodiment, the pop-up device 25a comprises two rods 38a, 38b. The rod 38a is pivotably articulated via the articulation 39a with the vehicle body 14 and via a second articulation 39d with the roof element 13. The rod 38b is articulated via a first articulation 39b with the vehicle body 14 and via a second articulation 39c with the roof element 13.

The two rods 38a, 38b are connected together in an articulated manner via a middle articulation 39e. In particular, the pop-up device 25a provides a kind of concertina grille.

Not illustrated but advantageously provided as an additional component of the pop-up device 25a is an articulated joint or other suitable holding device which ensures that the pop-up device 25a can keep the extended roof element 13 in the use position 16. The pop-up device 25 can also comprise, for example, spring elements or the like, not shown.

In the exemplary embodiment of FIG. 1, the roof element 13 is oriented with its sheet-form part 43 along a plane. Further exemplary embodiments, not shown, in which the sheet-form part 43 has any desired contour in space are likewise included in the invention.

In the exemplary embodiment of FIG. 1, the roof element 13 is oriented so as to be inclined slightly at an angle relative to the upper side 41 of the fixed, non-displaceable portion of the roof of the vehicle 12. Accordingly, the front edge 44 of the roof construction 11 has a larger gap 19b relative to the vehicle body 14 than the rear edge 45 of the roof construction 13. The front gap is denoted 19b, the rear gap 19a. The two gaps 19a and 19b can be the same or different.

However, the invention also includes roof constructions, not shown, in which the gaps 19a, 19b are identical.

In the spaced-apart position 18 of the roof element 13 according to FIG. 1, the gap 19a, 19b between the roof element 13 and the body 14 is bridged by a folding bellows 10. The folding bellows 10 is arranged in particular on the outside of the pop-up devices 25a, 25b.

Based on the circumferential direction 46 of the roof element 13, the folding bellows 10 is closed all the way round. In the opened state, the folding bellows 10 in the exemplary embodiment of FIG. 1 provides the entire wall region of the expanded interior of the vehicle 12.

In the exemplary embodiment of FIG. 1, the folding bellows 10 is thus configured in the manner of a tubular or cylindrical sleeve.

The invention equally includes roof constructions and folding bellows, not shown, in which the folding bellows is formed only in some portions in the circumferential direction 46 and comprises only material regions or parts of a wall of the expanded interior.

In an advantageous embodiment of the invention, a folding bellows 10 according to the invention is closed in the circumferential direction. In further exemplary embodiments, the folding bellows is open or interrupted in the circumferential direction.

As is apparent at first sight from comparing FIGS. 1 and 2, the folding bellows 10 is in an opened state 20 when the roof element 13 is in the use position 16. To this end, the folding bellows 10 is fixed with a first fixing region 47 indirectly or directly to the body 14 of the vehicle 12 and is fixed with a second fixing region 48 indirectly or directly to the roof element 13. The dimensions of the folding bellows 10 are, for example, such that, based on a maximum extension movement of the roof element 13, the length of the folding bellows in the extension direction Y is such that the folding bellows 10 is taut when the roof element 13 is in its use position. A corresponding illustration is shown in FIG. 3.

If the roof element 13 is transferred from the use position 16 according to FIG. 1 into its out-of-use position 17 according to FIG. 2, and if the roof element 13 is accordingly brought closer to the body 14, the gaps between the first fixing region 47 and the second fixing region 48 of the folding bellows become smaller. The folding bellows 10 therefore collapses in a compressed state.

Such a compressed state of the folding bellows 10 is shown in the illustrations of FIGS. 2 and 4. FIG. 4 is to be interpreted only schematically. FIG. 4 shows various fold plies 22a, 22b and a certain fold length 23. However, this is illustrated only for the purpose of showing the principle.

How the folding bellows 10 collapses in concrete terms depends on the geometry. Advantageously, the vehicle body 14 provides on the inside a receiving compartment for receiving the compressed folding bellows 10 collapsed in folds 22a, 22b.

It should be pointed out here, that, unlike in the schematic diagram of FIG. 2, the folding bellows 10 in the compressed state is generally covered or concealed by part of the body 14 of the vehicle 12 or by a screen element and—unlike in FIG. 2—a cover for the folding bellows 10 in the compressed state is also provided to protect the folding bellows from weather effects. A receiving compartment for the compressed folding bellows can be provided for this purpose on the body 14—which is not illustrated in the figures.

FIG. 4 shows, schematically, an even collapse in folds with a constant fold length 23. This is also to be interpreted only schematically. The collapse of the folding bellows 10 in folds 22a, 22b can take place with a constant fold length 23 or with different fold lengths 23. In particular, the fold length 23 of the individual folds 22, 22b when a folding bellows 10 is actually collapsed can of course vary.

In the region in which two different fold plies 22a, 22b are adjacent to one another there is a bending region 37a, 37b.

In folding bellows of the prior art, kinks or tears can form in particular along these bending regions. In order to prevent this, a particular layer structure 24 is provided according to the invention.

As is apparent from FIGS. 5 to 7, the folding bellows 10 consists in this exemplary embodiment of a layer structure 24 having three layers, comprising an outside layer 26 which faces the exterior of the vehicle 12 or the exterior of the folding bellows 10, an inside layer 27 which faces the interior of the vehicle 12 or the interior of the folding bellows 10, and an intermediate joining layer 28.

In the exemplary embodiments in FIGS. 5 to 7, the outside layer 26 is formed by a woven fabric 29, for example by a woven fabric of polyester. A corresponding woven fabric structure, which comprises a plurality of fibers or threads running in different directions, is shown in FIG. 6. The woven fabric 29 can have a regular or irregular structure of fibers.

In one exemplary embodiment of the invention, the outside layer 26 and the inside layer 27 are advantageously provided by a textile material. There are suitable, in addition to woven fabrics, also knitted fabrics or non-crimped fabrics. The material for the fibers of the woven fabric can be chosen as desired.

The joining layer 28, which is located between the two outer layers 26, 27, consists of or comprises a plastics material which is meltable under the action of heat.

FIG. 7 shows the corresponding layer structure 24 in a schematic illustration, in which the front regions, facing a viewer of FIG. 7, of the layers are arranged spaced apart from one another for the purposes of the illustration.

The three layers 26, 27, 28 can be fixed to one another as follows: The joining layer 28 or middle layer can consist of a hot-melt adhesive or of a thermoplastic or of a plastics material which softens under the action of heat. As a result of the action of heat, the material of the plastics material can melt for a short time and penetrate the structure of the outside layer 26 and of the inside layer 27.

FIG. 6 shows melted material regions 36a, 36b of the joining layer 28, which have penetrated or entered the outside layer 26 and the inside layer 27 beyond the layer boundaries 49a, 49b, illustrated in FIG. 6 by broken lines, which were originally present prior to melting.

After melting of the layers 28, the supply of further warmth or heat is interrupted. The melted material cools and thereby hardens. The three layers 26, 27, 28 are then fixedly joined together permanently.

The layer thicknesses of the three layers 26, 27, 28 can be chosen differently according to the intended use and requirements.

For conventional requirements, a total wall thickness of the layer structure 24, that is to say the sum of the three layers 26, 27, 28, of from 0.2 to 3 mm, in particular of approximately 1.2 mm, has been found to be particularly advantageous. Further advantageously—unlike what is shown in FIG. 6 and FIG. 7—the wall thicknesses of the outer layers 26, 27 are greater than the wall thickness of the middle joining layer 28 after melting.

The outside layer 26 has an outer side 30 and an inner side 31. The middle layer has an outer side 32 and an inner side 33. The inside layer 27 has an outer side 34 and an inner side 35.

The melted material regions 36a, 36b of the middle layer 28 or joining layer extend beyond the previously fixed outer sides 32 and inner sides 33, or layer boundaries 49a, 49b, of the inside layer and penetrate the structures of the outside layer 26 and of the inside layer 27. Such penetration of the melted material regions 36a, 36b is assisted by pressure rollers or calendar rollers or at least by the application of a contact pressure.

Extensive fixing of the various layers 26, 27, 28 to one another extensively over their entire surface is thereby provided.

It should be noted that, in further exemplary embodiments of the invention, such penetration of melted material regions and/or other regions of the adhesive or plastics material into the structures of the two outer layers 26, 27 does not take place or is not required. It can merely be provided in such cases, for example, that bonding is achieved over a large area without penetration of the material regions or adhesive regions into the outer layers 26, 27.

The layer structure 24 of the folding bellows 10 according to the invention makes it possible to achieve flexibility and stretchability properties and at the same time to generate elastic restoring forces in the bending regions 37: The collapsing behavior of the folding bellows 10 is thereby improved.

Even under frequent stress and when extreme compressive forces are applied, for example in the case where the folding bellows is not collapsed in the previously determined and intended manner, visible kink and folding points or the marks thereof, and thus the development of tears, can be avoided.

Likewise, point loads or linear loads can be mitigated by distributing the forces over large surface portions.

The layer structure 24 of the folding bellows according to the invention is in this respect in particular also capable of transmitting forces and distributing forces.

The present invention can be used in different roof constructions, which can be referred to, for example, as an elevating roof, raised roof or pop-up roof.

The layer structure 24 according to the invention of the folding bellows 10 permits particularly advantageous forms of the folding bellows 10 in terms of tightness, haptics, stretchability, kink resistance and also ease of installation.

For example, the fixing regions 47, 48 of the folding bellows 10 can be fixed to the body 14 or the roof element 13 in a particularly simple manner owing to the particular properties of the layer structure 24.

1-30. (canceled)

31. A roof construction for a motor vehicle, comprising a displaceable roof element which is displaceable between a retracted out-of-use position and an extended use position, wherein the roof element in the extended use position is in a spaced-apart position relative to a body of the vehicle, wherein there is arranged on the roof element a folding bellows which, when the roof element is in the use position, assumes an opened state and bridges a gap between the roof element and the body, and which, when the roof element is in the out-of-use position, assumes a compressed state collapsed in folds, wherein the folding bellows comprises a layer structure which has at least two different layers.

32. The roof construction according to claim 31, wherein the layer structure has three layers.

33. The roof construction according to claim 31, wherein the different layers are fixed to one another.

34. The roof construction according to claim 31, wherein the layer structure comprises layers of different materials.

35. The roof construction according to claim 31, wherein the layer structure comprises at least one layer of a textile material, in particular of a woven fabric, further in particular of a polyester woven fabric.

36. The roof construction according to claim 35, wherein the layer of textile material faces an exterior of the folding bellows.

37. The roof construction according to claim 31, wherein the layer structure comprises two layers, in particular of textile material, between which a joining layer is arranged.

38. The roof construction according to claim 31, wherein the layer structure comprises at least one layer of a plastics material or having a coating of plastics material.

39. The roof construction according to claim 37, wherein the joining layer is provided by a layer of a plastics material or comprises a coating of plastics material.

40. The roof construction according to claim 38, wherein the plastics material is provided by a thermoplastic plastics material and/or of a material such as PTFE (polytetrafluoroethylene), PU (polyurethane), PES (polyester).

41. The roof construction according to claim 38, wherein the plastics material is meltable, in particular hot-meltable.

42. The roof construction according to claim 31, wherein the different layers are fixed to one another in regions, in particular areally.

43. The roof construction according to claim 31, wherein the different layers are fixed to one another point-wise or line-wise.

44. The roof construction according to claim 31, wherein the layer structure is of flexible configuration.

45. The roof construction according to claim 31, wherein the layer structure is of resilient configuration.

46. A folding bellows for a roof construction for a motor vehicle, wherein the folding bellows can be transferred from an opened state into a compressed state collapsed in folds, comprising a layer structure which has at least two different layers.

47. The folding bellows according to claim 46, wherein the layer structure has three layers.

48. The folding bellows according to claim 46, wherein the different layers are fixed to one another.

49. The folding bellows according to claim 46, wherein the layer structure comprises layers of different materials.

50. The folding bellows according to claim 46, wherein the different layers are fixed to one another in regions, in particular areally.
